(19) United States
(12) Patent Application Publication
(10) Pub. No.: US 2026/0197357 A1
(43) Pub. Date: Jul. 9, 2026

(54) SYSTEM AND METHOD FOR ENABLING COMMUNICATION BETWEEN HOST AND NON-HOST VIDEO CONFERENCE PLATFORMS

(71) Applicant: Samsung Electronics Co., Ltd., Suwon-si (KR)

(72) Inventor: Manyu KUMAR, Noida (IN)

(21) Appl. No.: 19/556,479

(22) Filed: Mar. 4, 2026

Related U.S. Application Data
(63) Continuation of application No. PCT/KR2024/014102, filed on Sep. 19, 2024.

(30) Foreign Application Priority Data
Sep. 22, 2023 (IN) 202311063939

(51) Int. Cl. H04L 65/401; G06F 3/0482; G06F 3/0484; H04L 65/403

(52) U.S. Cl. CPC H04L 65/4015; H04L 65/403; G06F 3/0482; G06F 3/0484

(57) ABSTRACT

A system for enabling communication between host and non-host video conference platforms is provided. The system includes a video conferencing agent for generating and embedding a chat link with a live video session starting on the host video conference platform and broadcasting the chat link embedded video session to one or more non-host video conference platforms, wherein the non-host video conference platforms are different than the host video conference platform, an identification generator for generating a unique identification (ID) for each user of the non-host video conference platforms in response to a click on the chat link and appending the generated unique ID and timestamp with each message from the user and appending the timestamp with a response received on the message from a user of the host video conference platform or from a second user of the non-host video conference platform, a response sharer for generating a chat user interface (UI) to display the message from the user of the non-host video conference platform along with the generated unique ID and response from the user of the host video conference platform or from the second user on each platform, wherein the chat UI incorporates a toggling function to enable the user to select a conference platform of interest, and a dynamic chat room generator for receiving and categorizing each message and response from the response sharing module by performing natural language processing, creating a secondary chat room based on the categorization, and associating a timer with the categorized chat room.

### CROSS-REFERENCE TO RELATED APPLICATION(S)

This application is a continuation application, claiming priority under 35 U.S.C. § 365 (c), of an International application No. PCT/KR2024/014102, filed on Sep. 19, 2024, which is based on and claims the benefit of an Indian Patent Application number 202311063939, filed on Sep. 22, 2023, in the Indian Patent Office, the disclosure of which is incorporated by reference herein in its entirety.

### BACKGROUND

### 1. Field

The disclosure relates to communication between different video conference platforms. More particularly, the disclosure relates to a system and method for enabling bi-directional communication between host and non-host video conference platforms.

### 2. Description of Related Art

In modern digital era, video conferencing has become an essential communication tool. The video conferencing allows individuals located in different parts of the world to participate in meetings, broadcasting seminars, hosting conferences, facilitating virtual classrooms, communicating, and collaborating through video screens. While video conferencing platforms offer convenience and flexibility, they often come with limitations, particularly regarding number of users that can join. This limitation becomes more apparent when hosting virtual seminars and conferences, where need for wider participation is crucial to facilitate knowledge sharing and engagement. To address this limitation of the video conference platforms, the practice of broadcasting conferences on non-host video conference platforms such as social media platforms has gained popularity. This method allows for a broader audience reach and wider participation, enabling individuals to access the conference from various locations. This method also opens up opportunities for content creators to share their knowledge and expertise with a larger audience.

However, despite the advantages of broadcasting conferences on non-host video conference platforms, a significant challenge arises in terms of interactivity. Users from the non-host video conference platforms are unable to actively engage in real-time discussions, ask questions, or interact with the host and also with users from other platforms. This one-way communication limits the potential for meaningful interaction and collaboration.

Therefore, it is crucial to provide a system or method that can provide communication between host and non-host video conference platforms.

Numerous prior art solutions exist that disclose broadcasting of content on multiple platforms.

The existing prior art discloses a live streaming and configuration method based on cloud phones, and related apparatus and system. The method includes a plurality of steps such as a content distribution service node receives live streaming content from an anchor terminal. This content is sent to a stream pushing address of the content distribution service node. Then, the content distribution service node associates the received live streaming content with a stream pulling address of the content distribution service node. In one embodiment, the live streaming content is generated by the anchor terminal. The plurality of step further includes the involvement of at least two cloud phones. These cloud phones individually pull the live streaming content from the stream pulling address of the content distribution service node. Subsequently, each cloud phone sends the live streaming content to different live streaming platforms. Therefore, the objective of enabling multiple cloud phones to share the live streaming content produced by the anchor terminal for live streaming can be accomplished. This solution addresses the challenges associated with high costs, subpar interaction effects, and potential stuttering that are often encountered in multi-platform live streaming systems.

However, the existing prior art does not disclose generation of a chat user interface (UI) on each platform to display the messages from the user, along with the generated identification (ID). Furthermore, the prior art does not disclose the incorporation of a toggling function in the chat UI, allowing the user to select a conference platform of interest. Additionally, the prior art does not address reception of responses on the user's message from both the host video conference platform and other user of the non-host video conference platform, as well as integration of these responses in the chat UI with respect to the user's message on the non-host video conference platform.

Further, the prior art discloses a system and method for sharing content in a live stream and story application. The prior art further discloses mobile application technology which has a dynamic workflow integrated with a multiple network to form an integrated processing framework. The prior art further discloses a system that has been built into a network where the live stream interface allows users to go live on multiple live stream providers simultaneously or by specific selection. Additionally, the prior art discloses an integrated mobile platform where users are able to stream live on all social media platforms or the ones they have selected by specific social media application programming interface (API). Furthermore, the prior art discloses about story interface which allows users to record a video clip for few seconds and share with selected social media API's.

However, the existing prior art does not disclose generation of a chat user interface (UI) on each platform to display the messages from the user, along with the generated ID. Furthermore, the prior art does not disclose incorporation of a toggling function in the chat UI, allowing the user to select a conference platform of interest. Additionally, the prior art does not address the reception of responses on the user's message from both the host video conference platform and a second user of the non-host video conference platform, as well as the integration of these responses in the chat UI with respect to the user's message on the non-host video conference platform.

Therefore, in light of the foregoing discussion, there exists a need to overcome the aforementioned drawbacks associated with the existing system and method for enabling communication between host and non-host video conference platforms.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a system and method for enabling bi-directional communication between host and non-host video conference platforms.

Additional aspects will be set forth in part in the description which follows and, in part, will be apparent from the description, or may be learned by practice of the presented embodiments.

In accordance with an aspect of the disclosure, a method for enabling communication between host and non-host video conference platforms is provided. The method includes broadcasting a live video session embedded with a chat link to one or more non-host video conference platforms, wherein the live video session is started on the host video conference platform, generating a unique identification (ID) for each user of the non-host video conference platforms in response to a click on the chat link and appending the generated unique ID and timestamp with each message from the user, generating a chat user interface (UI) on each platform to display the message from the user along with the generated unique ID, wherein the chat UI incorporates a toggling function to enable the user to select a conference platform of interest, and receiving a response on the message from a user of the host video conference platform or from a second user of the non-host video conference platform and integrating the response in the chat UI with respect to the message of the user of the non-host video conference platform.

In an embodiment, the method further includes creating a context based secondary chat room to display message and responses of same context. The chat bot is utilized to create the secondary chat room using natural language processing. The chat room provides a dedicated space for users to view and engage in conversations related to a specific topic or context. It should be noted that the secondary chat room is associated with a timer which is decided based on a sentiment score of the users of the chat room.

In accordance with another aspect of the disclosure, a system for enabling communication between host and non-host video conference platforms is provided. The system includes a video conferencing agent for generating and embedding a chat link with a live video session starting on the host video conference platform and broadcasting the chat link embedded video session to one or more non-host video conference platforms, wherein the non-host video conference platforms are different than the host video conference platform, an identification generator for generating a unique identification (ID) for each user of the non-host video conference platforms in response to a click on the chat link and appending the generated unique ID and timestamp with each message from the user and appending the timestamp with a response received on the message from a user of the host video conference platform or from a second user of the non-host video conference platform, a response sharer for generating a chat user interface (UI) to display the message from the user of the non-host video conference platform along with the generated unique ID and response from the user of the host video conference platform or from the second user on each platform, wherein the chat UI incorporates a toggling function to enable the user to select a conference platform of interest, and a dynamic chat room generator for receiving and categorizing each message and response from the response sharing module by performing natural language processing, creating a secondary chat room based on the categorization, and associating a timer with the categorized chat room.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include broadcasting a live video session embedded with a chat link to one or more non-host video conference platforms, wherein the live video session is started on the host video conference platform, generating a unique identification (ID) for each user of the non-host video conference platforms in response to a click on the chat link and appending the generated unique ID and timestamp with each message from the user, generating a chat user interface (UI) on each platform to display the message from the user along with the generated unique ID, wherein the chat UI incorporates a toggling function to enable the user to select a conference platform of interest, and receiving a response on the message from a user of the host video conference platform or from a second user of the non-host video conference platform and integrating the response in the chat UI with respect to the message of the user of the non-host video conference platform.

In an embodiment, the video conferencing agent creates a user datagram protocol (UDP) server and UDP client sockets implementation for communications.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 depicts a flow diagram showing a method for enabling communication between host and non-host video conference platforms, according to an embodiment of the disclosure;

FIG. 2 depicts a block diagram of a system performing method for enabling communication between host and non-host video conference platforms, according to an embodiment of the disclosure;

FIG. 3 depicts a block diagram of a video conferencing agent, according to an embodiment of the disclosure;

FIG. 4 depicts a block diagram of an identification generating module, according to an embodiment of the disclosure;

FIG. 5 depicts a block diagram of a response sharing module, according to an embodiment of the disclosure;

FIG. 6 depicts a sharing framework of the response sharing module, according to an embodiment of the disclosure;

FIG. 7 depicts an implementation of toggling function on chat user interface (UI), according to an embodiment of the disclosure;

FIG. 8 depicts a block diagram of a dynamic chat room generating module, according to an embodiment of the disclosure;

FIG. 9 depicts a natural language framework for a secondary chat room, according to an embodiment of the disclosure;

FIG. 10 depicts presentation of an output on a user interface (UI) of a non-host video conference platform, according to an embodiment of the disclosure;

FIG. 11 depicts a UI framework, according to an embodiment of the disclosure; and

FIG. 12 depicts a first use case of enabling communication between host and non-host video conference platforms, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Additionally, it may be noted that the systems and/or methods are shown in block diagram form only in order to avoid obscuring the present disclosure. It is to be understood that various omissions and substitutions of equivalents may be made as circumstances may suggest or render expedient to cover various applications or implementations without departing from the spirit or the scope of the present disclosure. Further, it is to be understood that the phraseology and terminology employed herein are for the purpose of clarity of the description and should not be regarded as limiting.

Furthermore, in the present description, references to “one embodiment” or “an embodiment” means that a particular feature, structure, or characteristic described in connection with the embodiment is included in at least one embodiment of the present disclosure. The appearance of the phrase “in one embodiment” in various places in the specification is not necessarily referring to the same embodiment, nor are separate or alternative embodiments mutually exclusive of other embodiments. Further, the terms “a” and “an” used herein do not denote a limitation of quantity, but rather denote the presence of at least one of the referenced items. Moreover, various features are described which may be exhibited by some embodiments and not by others. Similarly, various requirements are described, which may be requirements for some embodiments but not for other embodiments.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

A video conferencing platform facilitates real-time, face-to-face interactions between users who may be located in different geographic locations. In order to reach a broader audience and encourage wider participation, it is generally required to broadcast the conference on social media platforms or non-host video conferencing platforms. However, it can be challenging to facilitate seamless two-way communication between users on host and non-host video conferencing platforms, which is crucial for a better interactive session, which the disclosure aims to provide.

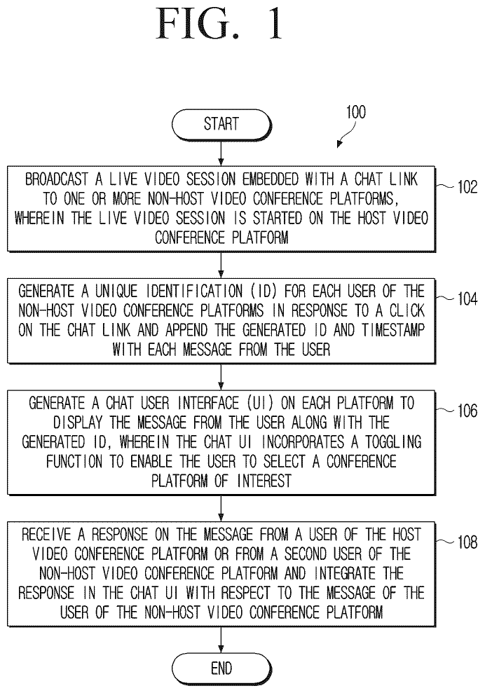

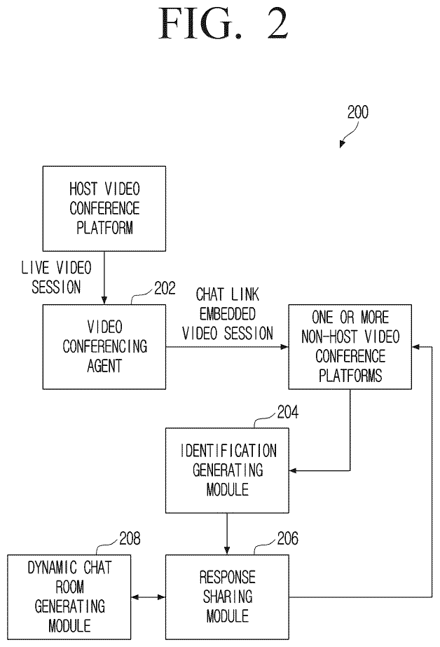

The method may be explained in conjunction with the system disclosed in FIG. 2. In the flow diagram, each block may represent a module, segment, or portion of code, which comprises one or more executable instructions for implementing the specified logical function(s). It should also be noted that in certain alternative implementations, the sequence of functions depicted in the drawings may not necessarily occur in the exact order as indicated. For example, two blocks shown in succession in FIG. 1 may be executed substantially concurrently or the blocks may sometimes be executed in the reverse order, depending upon the functionality involved. Any process descriptions or blocks in flowcharts should be understood as representing segments, modules, or portions of code that include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in the flow charts should be understood as representing decisions made by a hardware structure such as a state machine. The flow diagram starts at operation 102 and proceeds to operation 108.

FIG. 1 depicts a flow diagram showing a method for enabling communication between host and non-host video conference platforms, according to an embodiment of the disclosure.

Referring to FIG. 1, at operation 102 of method 100, a live video session embedded with a chat link is broadcasted to one or more non-host video conference platforms. The one or more non-host video conference platforms are different than the host video conference platform and the live video session is started on the host video conference platform. It should be noted that the chat link enables users on the non-host platforms to join a chat or messaging feature associated with the video conference to communicate or ask questions to user hosting the video or other users of the non-host platforms, share information, and engage in discussions related to the video session.

Successively, a unique identification (ID) is generated for each user of the non-host video conference platforms and the generated ID along with a timestamp is appended with each message from the user, at operation 104. The message may include at least a text message, an audio message, or a video message. In one embodiment, the unique ID is generated for each user of the non-host video conference platforms in response to a click on the chat link. The unique ID includes a user ID and a platform ID. This combination allows for the creation of a distinct identifier that can be used to differentiate users across different platforms. The user ID serves as a unique identifier for each individual user and the platform ID represents the specific platform or application being used.

In one embodiment, the unique ID and timestamp are generated by a Bot or a software program or application to ensure consistency and accuracy in generating the IDs and timestamps for each user and message. The bot or program or application responsible for generating these IDs and timestamps may follow a predefined algorithm or logic to ensure uniqueness and reliability. By appending the generated ID and timestamp to each message sent by the user, it becomes easier to associate messages with specific users and track the chronology of the conversation. This facilitates seamless communication and enhances the overall user experience during the video conference session.

Successively, a chat user interface (UI) is generated on each platform, at operation 106, to display the message from the user along with the generated ID. The chat UI is generated on each platform based on request of the user of the non-host video conference platforms and response from the host video conference platform and the chat UI is destroyed after the live video session concludes. In one embodiment, the chat UI incorporates a toggling function to enable the user to select a conference platform of interest. It should be noted that the chat UI includes a drop-down menu for toggling messages or responses, the drop-down menu includes a plurality of conference platforms and enabling the user to select the conference platform of interest.

In one embodiment, a separate chat user interface (UI) which is a context based secondary chat room is generated by the chat bot using natural language processing. This secondary chat room is designed to display messages and responses that pertain to same topic or context. The purpose of this separate chat UI is to provide a dedicated space for users to engage in focused conversations related to a specific subject or context.

By utilizing natural language processing, the chat bot is able to analyze content of messages and determine their context, allowing for the appropriate grouping and display of related messages within this secondary chat room. This context-based chat room enhances the organization and clarity of conversations within the video conference platform. It should be noted that the secondary chat room may be associated with a timer which is decided based on a sentiment score of the users of the chat room.

Thereafter, a response is received on the message from a user of the host video conference platform or from a second user of the non-host video conference platform and the response is integrated in the chat UI with respect to the message of the user of the non-host video conference platform, at operation 108. The integration of the response involves displaying it in the chat UI in a way that maintains the context and connection to the corresponding message. This ensures that users in the video conference can easily follow the conversation and understand the relationships between different messages and responses.

FIG. 2 depicts a block diagram of the system performing method for enabling communication between host and non-host video conference platforms, according to an embodiment of the disclosure.

Referring to FIG. 2, the system (200) comprises a video conferencing agent (202) which is configured for generating and embedding a chat link with a live video session starting on the host video conference platform. In an embodiment, the host video conference platform refers to a platform or software that is used by a user or an organization to host a video conference. This platform offers a wide range of features to facilitate effective communication and collaboration, including video and audio streaming, screen sharing, chat messaging, recording, and various collaboration tools. Examples of popular host video conference platforms include Zxxx, Gxxxxx Mxxx, Mxxxxxxxx Txxxx, Cxxxx Wxxxx, and others.

The video conferencing agent (202) is further configured for creating a user datagram protocol (UDP) server and UDP client sockets implementation for each embedded link for communications. The video conferencing agent (202) creates the UDP server, which acts as a receiver, listening for incoming datagrams on a specific port. This server is specifically dedicated for handling communication for the embedded links. On the other hand, the UDP client socket functions as the sender, allowing the video conferencing agent (202) to send datagrams to the designated users. By utilizing the UDP, the video conferencing agent (202) enables efficient and real-time communication between the users connected through the embedded links.

In an embodiment, the server-client session is created through utilization of an application programming interface (API) specifically when the user of the one or more non-host video conference platforms clicks on the chat link. This API is responsible for initiating creation of the server-client session, which in turn generates a user interface for the chat session. The chat sessions on all platforms are established in response to request of the user of the non-host video conference platforms and host responses. Once the chat session is successfully established, it remains active until it is explicitly terminated. The destruction of the chat user interface is triggered by invoking the Destroy ( ) API.

The video conferencing agent (202) is further configured for broadcasting the chat link embedded video session to one or more non-host video conference platforms. In an embodiment, the non-host video conference platforms are video conferencing services that allow users to join conferences or meeting or seminars hosted by someone else by simply clicking on the broadcasted video session. In another embodiment, the user requires to click on a broadcasted meeting link or enter a meeting ID to access the video session.

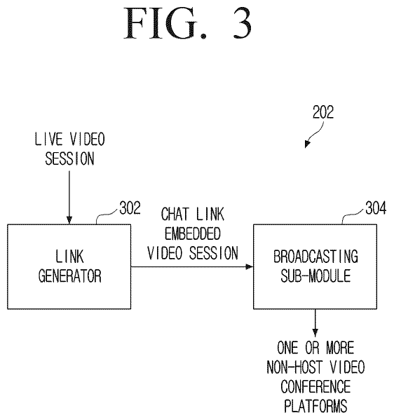

These non-host video conference platforms may have different functionalities and features compared to host video conference platforms, and they are often used for larger-scale events that require wider audience reach. Examples of non-host video conference platforms include Yxxxxxx, Fxxxxxxx, and similar platforms that offer live streaming capabilities. The video conferencing agent (202) may be explained in detail using FIG. 3.

FIG. 3 depicts a block diagram of the video conferencing agent (202), according to an embodiment of the disclosure.

Referring to FIG. 3, the video conferencing agent (202) comprises a link generator (302) and a broadcasting sub-module (304).

The link generator (302) is configured for generating a chat link. In an embodiment, the chat link is a clickable link that allows users of the non-host video conference platforms to easily access and enables a chat user interface for interactive communication during a video conference session. The link generator (302) is further configured for embedding the generated chat link with the live video session starting on the host video conference platform.

In an embodiment, these embedded links are a type of hyperlink that uses anchor text to create a link to another web page using the hypertext transfer protocol (HTTP) protocol. These embedded links may be created by applying some basic hypertext markup language (HTML) coding or by using WordPress editors and may be included within various elements such as, but not limited to, text or images or even within other applications like an email client.

The broadcasting sub-module (304) is configured for broadcasting the chat link embedded video session to one or more non-host video conference platforms. When broadcasting the chat link embedded video session on the non-host video conference platforms, such as social media, websites, or email invitations, it is beneficial to provide additional information or context about the video session. This is typically done by including a description that accompanies the video session details. In this description, clickable links may be added to provide quick access to relevant resources or to initiate specific actions, such as opening a chat user interface.

In an embodiment, the chat link embedded video session is broadcasted by utilizing a packet transmission. This involves encapsulating the video session data into packets that contain medium access control (MAC), internet protocol (IP), transmission control protocol) (TCP)/UDP headers, and the actual data. These packets are fragmented for efficient transmission.

The broadcasting sub-module (304) handles transmission of packets from upper layer to lower layer, when they are transmitted over the internet. The packets then traverse through the network, moving from lower layer to upper layer, until they reach the intended receiver. This transmission process allows for the simultaneous transfer of packets between the host and non-host platforms.

The packets from the broadcasting sub-module (304) include source and destination addresses, indicating the origin and destination of the data transfer. These addresses specify the path through which the packets will be transferred, typically involving communication with a server. All the platforms or nodes involved in the video session, including the host and non-host platforms, are interconnected through the internet. The packets are transmitted from one node to another, facilitating the exchange of data and enabling seamless communication during the video session.

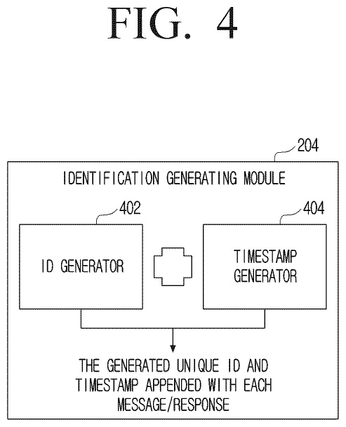

The system (200) further comprises an identification generating module (204) which is configured for generating a unique identification (ID) for each user of the non-host video conference platforms in response to a click on the chat link and appending the generated unique ID and timestamp with each message and each response. The identification generating module (204) may be explained in detail using FIG. 4.

FIG. 4 depicts a block diagram of the identification generating module, according to an embodiment of the disclosure.

Referring to FIG. 4, the identification generating module (204) comprises an identification generator (402) and a timestamp generator (404).

The identification generator (402) is configured for generating a unique identification (ID) for each user of the non-host video conference platforms in response to a click on the chat link. In an embodiment, when the user of the non-host video conference platform clicks on the chat link embedded with the video session, the identification generator (402) is triggered to generate the unique ID for that particular user. This ID serves as a unique identifier to differentiate and track individual users within the video conference platform during the video session.

The generated unique ID includes a user ID and a platform ID. In an embodiment, the user ID may be a randomly generated alphanumeric code or any other unique identifier assigned to the user. The user ID helps differentiate one user from another within the video conference session. The platform ID, on the other hand, represents the specific non-host video conference platform that the user is utilizing. It may be a code or name assigned to each platform to distinguish them from one another. The combination of the user ID and platform ID provides a more granular identification for each user in the video conference, allowing for precise tracking and management of user interactions.

The timestamp generator (404) is configured for generating a timestamp for each message from the user of the non-host video conference platform and for each response received on the message from the user of the host video conference platform or from any other user of the non-host video conference platform. With the help of timestamps, it becomes possible to determine the relative ordering of messages and responses, even in scenarios where there may be delays or out-of-order delivery.

In an embodiment, the unique ID and the time stamp both are generated by a Bot or a software program or application. In another embodiment, the unique ID is generated by utilizing a universally unique identifier or a globally unique identifier and the time stamp is generated by utilizing a system clock, a network time protocol, or timestamping services, etc.

On successful generation of the unique ID and timestamps, the identification generating module (204) is configured for appending the generated unique ID and timestamp with each message and each response to trace and track the flow of communication during the video session.

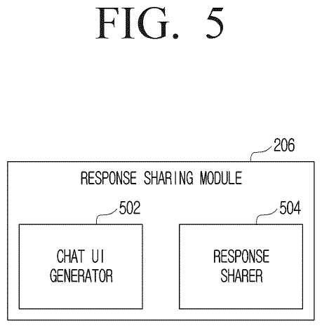

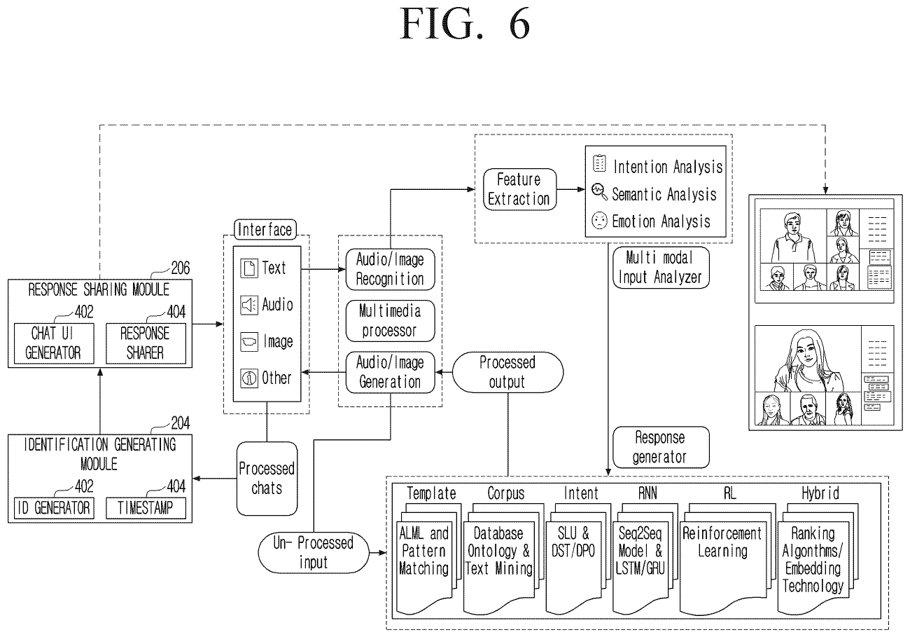

The system (200) further comprises a response sharing module (206). The response sharing module (206), after getting response from the identification generating module (204) which generated the unique ID and timestamp, is configured for generating a chat user interface (UI) to display the message along with the generated ID and response from the user of the host video conference platform or from the second user on each platform, which may be explained in detail using FIGS. 5 and 6.

FIG. 5 depicts a block diagram of a response sharing module (206), according to an embodiment of the disclosure.

Referring to FIG. 5, the response sharing module (206) comprises a chat user interface (UI) generator (502) and a response sharer (504).

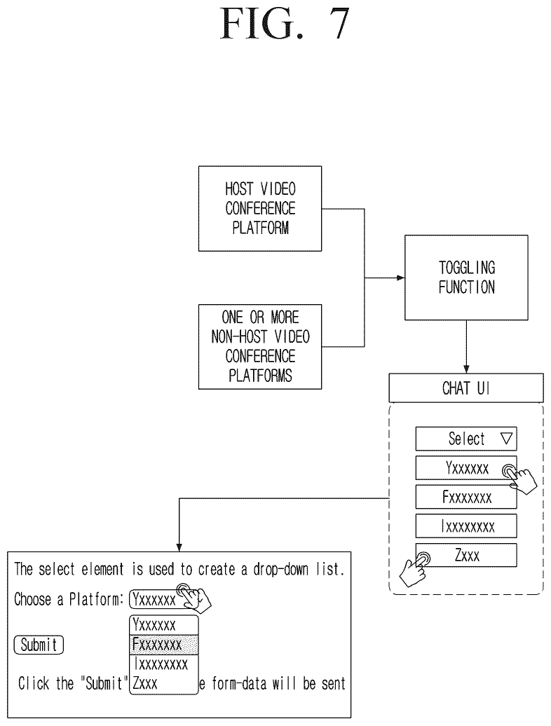

In one embodiment, the chat UI generator (502) is configured for generating a chat UI. The chat UI is generated on each platform based on request of the user of the non-host video conference platforms and response from the host video conference platform and the chat UI is destroyed after the live video session concludes. In an embodiment, the chat UI incorporates a toggling function to enable the user to select a conference platform of interest. The toggling function may be explained in detail using FIG. 7.

The response sharer (504) is configured for sharing the message from the user of the non-host video conference platform along with the generated ID and response from the user of the host video conference platform or from the second user on each platform.

FIG. 6 depicts a sharing framework of the response sharing module (206), according to an embodiment of the disclosure.

Referring to FIG. 6, the response sharing module (206) is configured to take the messages as well as responses received from the identification generating module (204) as input. As depicted in the framework, there are several smaller modules that work together to generate chat UI along with the video session based on sentiments of the messages and the chat UI then displayed on the platforms based on processed outputs.

For example, if the message is classified as positive or happy, the chat UI may include visual elements or text that conveys positivity. Conversely, if the message is classified as negative or sad, the chat UI may display elements that convey empathy or support.

In one embodiment, sentiments of the messages are analyzed by utilizing multi modal input analyzer on extracted features of the message. The multi modal input analyzer may use various algorithms and models to process the multimodal input. For example, it may apply sentiment analysis algorithms to analyze the sentiment expressed in text inputs, computer vision algorithms to extract visual features from images or videos, and acoustic analysis techniques to analyze audio inputs.

FIG. 7 depicts an implementation of the toggling function on the chat UI, according to an embodiment of the disclosure.

Referring to FIG. 7, the chat UI includes a drop-down menu that allows users to toggle between different messages or responses. This drop-down menu discloses a plurality of conference platforms and enables the user to choose the specific conference platform they are interested in. It should be noted that the toggling function 700 may be enabled by the user of the host video conference platforms when there are multi-platform users connected through it. This means that users on different platforms can utilize the toggling feature on choice only when the toggling function is enabled by the user of the host video conference.

The purpose of the toggling function is to allow users to check messages that are specific to a particular platform. The toggling function may be displayed on the message and/or response section of the user interface and providing a convenient way for users to access this functionality. This functionality is particularly useful when a large quantity of responses is being received simultaneously, as the toggling feature helps manage and navigate through the responses more effectively.

In an embodiment, when there are more than 1000 participants across multiple platforms joining and interacting, resulting in a large volume of incoming chats that can create chaos in the chat room. To prevent this, the toggling functionality may be implemented to check particular platform's chat. This helps in organizing and managing the chat conversations based on the platform they originated from.

Further, the toggling functionality may be implemented to check sentiments of users on specific platforms. This may be helpful in understanding overall mood or opinions shared by participants on a specific platform.

The toggling functionality may also be implemented to evaluate performance of video conference platforms across platforms. This evaluation may help identify any potential issues or strengths of each platform.

Additionally, the toggling functionality may be implemented to interact with users on specific platforms and provide responses. This provides an opportunity to reply and respond to the users on that platform more effectively, ensuring that their queries and comments are acknowledged and addressed.

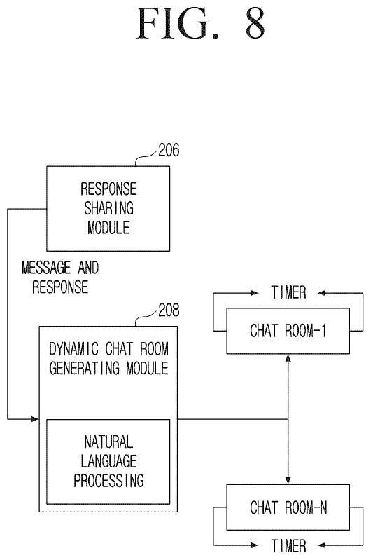

The system further comprises a dynamic chat room generating module (208), which is configured for receiving and categorizing each message and response from the response sharing module (206) by performing natural language processing (NLP), creating a secondary chat room based on the categorization, and associating a timer with the categorized chat room, which may be explained in detail using FIG. 8.

FIG. 8 depicts a block diagram of a dynamic chat room generating module, according to an embodiment of the disclosure.

Referring to FIG. 8, the dynamic chat room generating module (208) is configured for using a Chatbot for creating separate chat rooms or secondary chat rooms based on the sentiments expressed in bulk replies and comments to enhance the chat experience. It should be noted that the Chatbot may analyze the text and identify sentiment-related rooms by utilizing the NLP and create separate chat rooms dynamically.

As depicted, these separate chat rooms or secondary chat rooms are associated with the timer which is decided based on a sentiment score of the users of the chat room. Once the timer is finished, these sentiment-related chat rooms may be automatically destroyed, ensuring efficient use of resources.

In an embodiment, the NLP includes components such as information retrieval, tokenizes term frequency-inverse document frequency, Convolutional Neural Network (CNN) for text classification, and sentiment analysis.

The Information retrieval is a critical task for search and recommendation systems. The objective is to retrieve the most relevant documents from a vast collection, which could consist of millions of documents. The goal is not just to answer a specific query, but rather to find a set of documents that are highly relevant to the query. This process involves sophisticated algorithms and techniques to rank and retrieve the most appropriate documents.

The Tokenizers: Term Frequency-Inverse Document Frequency (TF-IDF) is a numerical statistic used to measure importance or relevance of a word within a document, by considering its frequency in the document and its rarity across a collection of documents. The TF component calculates frequency of a term within a document. It can be measured in various ways, such as the raw count of occurrences or by adjusting for the document's length.

The IDF component measures the rarity of a term across the corpus. It is calculated by taking the logarithm of the inverse of the fraction of documents that contain the term. If a term appears in many documents, its IDF score will be lower, indicating that it is less important or distinctive. Conversely, if a term appears in fewer documents, its IDF score will be higher, indicating that it is more important or distinctive.

TF-IDF is commonly used in the information retrieval and allows for identification of important words or terms that are likely to capture the essence or key characteristics of a document.

The Convolutional Neural Network (CNN) for text classification is used to treat a document as an image, and CNN architecture is employed to extract meaningful features from the text. It should be noted that the CNN for text classification typically consist of convolutional layers followed by pooling layers and fully connected layers. The convolutional layer applies a set of filters or kernels to the input data. These filters slide over the input and perform convolution operations, extracting local features or patterns. Each filter detects specific patterns or features at different positions in the text. After the convolutional layer, a pooling layer is typically applied to reduce the dimensionality of the extracted features. Common pooling operations include max pooling or average pooling, which select the maximum or average value within a window of features. The output of the pooling layer is flattened and fed into fully connected layers, which perform classification based on the extracted features. These layers can have multiple neurons, and activation functions like ReLU or softmax are often used. The final layer of the CNN is the output layer, which produces the predicted class probabilities or labels for the input text.

The sentiment analysis is a process that involves classifying the emotional intent of text. Typically, a sentiment classification model takes a piece of text as input and predicts the probability of the sentiment being positive, negative, or neutral. This analysis can be useful for understanding the overall sentiment expressed in a large volume of text data, such as customer reviews, social media posts, or comments.

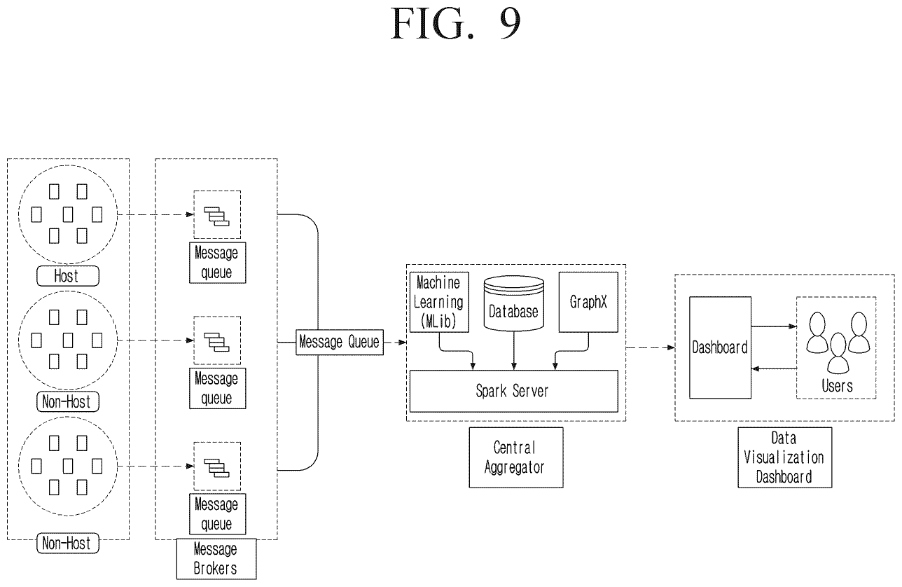

FIG. 9 depicts the natural language framework for the secondary chat room, according to an embodiment of the disclosure.

Referring to FIG. 9, the framework encloses device agent clusters, a message broker, a central aggregator, and a data visualization dashboard.

In one embodiment, the device agent clusters encompass both host and non-host clusters responsible for managing all chats including messages and responses.

The message broker is employed to segregate similar chats and enable separate chat UIs.

The central aggregator incorporates a Spark server that is connected to machine learning, a database, and GraphX. It should be noted that the spark is a powerful analytics engine that can handle large-scale data processing tasks and the GraphX is a component of the Spark that provides a graph processing framework for big data analysis and computation.

Additionally, a central database is utilized to categorize users' queries based on pre-classified data. The data visualization dashboard facilitates separate chat boxes where groups of participants can assist each other by providing reply responses to queries of a similar nature.

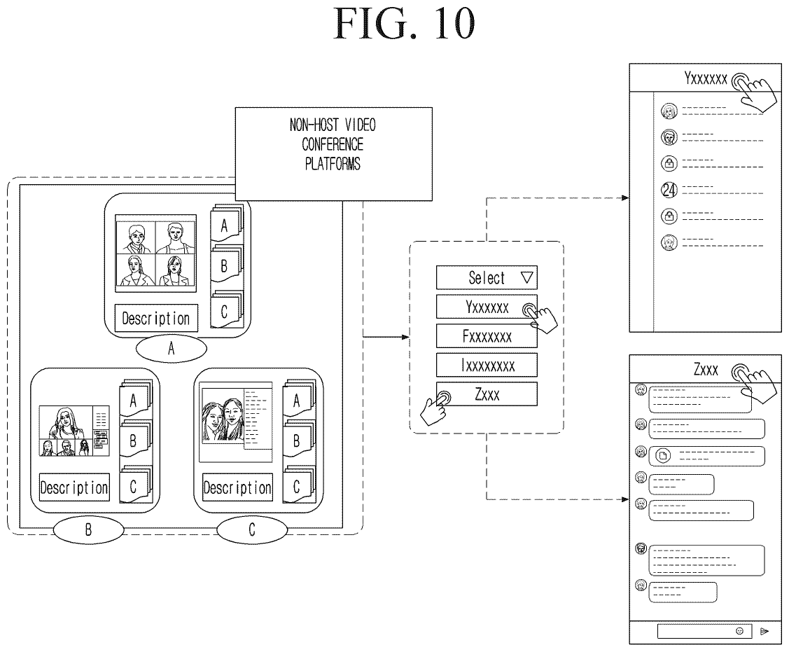

FIG. 10 depicts presentation of the output on the user interface (UI) of the non-host video conference platform, according to an embodiment of the disclosure.

Referring to FIG. 10, all the non-host video conference platforms (A, B, and C) are provided with an inter-platform chatting or interaction facility, which means the users have the flexibility to switch between platforms and participate in cross-platform conversations based on their interests and preferences.

Unlike earlier solutions that had limitations on the number of participants due to server load, the present system allows for an increased number of users to join meetings or discussions. This scalability ensures a smoother and more inclusive user experience. The final output of this multi-platform approach aims to enhance the overall user experience by providing seamless interaction and collaboration opportunities across different platforms.

Users can connect and engage with each other, even if they are using different platforms. This integrated ecosystem fosters communication and encourages cross-platform interaction, ultimately creating a richer and more interconnected user community.”

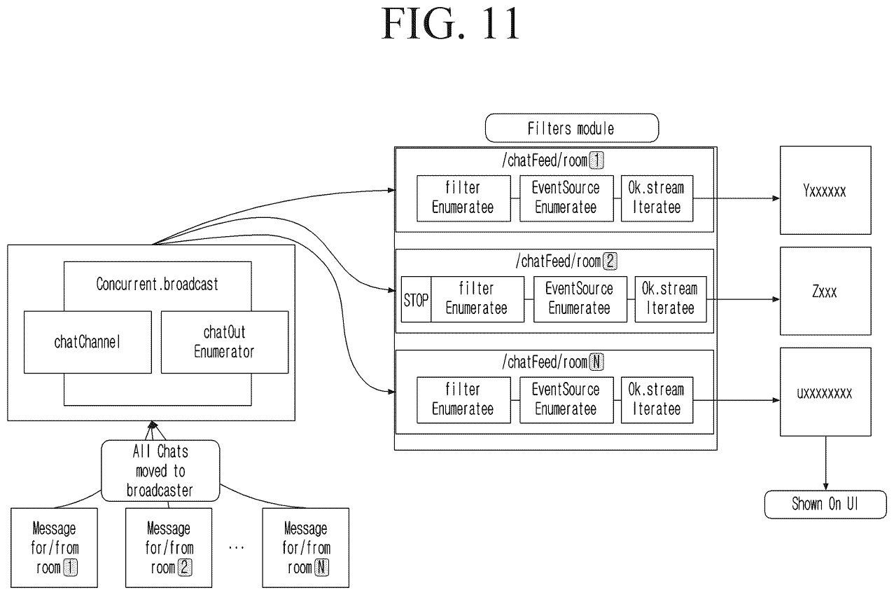

FIG. 11 depicts a UI framework, according to an embodiment of the disclosure.

Referring to FIG. 11, all chats from the secondary chat room are broadcasted. Users of non-host video conference platforms have the option to select the platforms from which they want to view the chats. When these users apply filters using toggling functions, the chats that do not meet their criteria may be stopped, based on their individual choices. These filters include filter modules such as “Filter,” “Event Source,” “Ok.stream.” This ensures that all chats may be broadcasted across the platforms, while allowing users to customize their chat viewing experience.

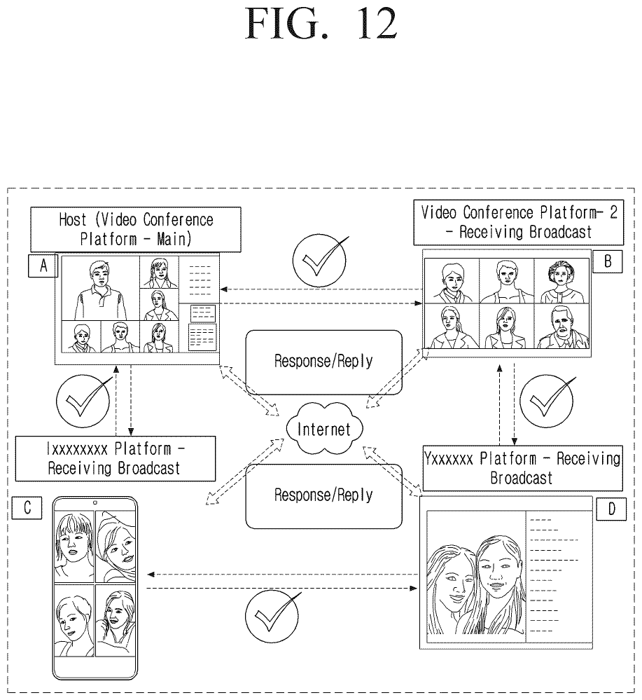

FIG. 12 depicts a first use case of enabling communication between host and non-host video conference platforms, according to an embodiment of the disclosure.

Referring to FIG. 12, in a scenario where a live session is hosted on Mxxxxxxxx Txxxx, there is a limitation on the number of participants who can join in a single session. Therefore, there is a need for simultaneous live sharing of the session on platforms such as Yxxxxxx or Zxxx.

By implementing the disclosure, it is possible to broadcast the live session on multiple platforms, allowing users to access the session through various platforms. Additionally, a bidirectional communication is enabled between the host video conference platform (Mxxxxxxxx Txxxx) and other non-host video conference platforms like Yxxxxxx, Zxxx, and Ixxxxxxxx. This enables users on these non-host platforms to actively participate in the session by providing replies and responses.

It has thus been seen that the system and method for enabling communication between host and non-host video conference platforms according to the disclosure achieve the purposes highlighted earlier. Such a system and method can in any case undergo numerous modifications and variants, all of which are covered by the same innovative concept, moreover, all of the details can be replaced by technically equivalent elements.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A system for enabling communication between host and non-host video conference platforms, the system comprises:
a video conferencing agent for generating and embedding a chat link with a live video session starting on the host video conference platform and broadcasting the chat link embedded video session to one or more non-host video conference platforms, wherein the non-host video conference platforms are different than the host video conference platform;
an identification generator for generating a unique identification (ID) for each user of the non-host video conference platforms in response to a click on the chat link and appending the generated unique ID and timestamp with each message from the user and appending the timestamp with a response received on the message from a user of the host video conference platform or from a second user of the non-host video conference platform;
a response sharer for generating a chat user interface (UI) to display the message from the user of the non-host video conference platform along with the generated unique ID and response from the user of the host video conference platform or from the second user on each platform, wherein the chat UI incorporates a toggling function to enable the user to select a conference platform of interest; and
a dynamic chat room generator for receiving and categorizing each message and response from the response sharing module by performing natural language processing, creating a secondary chat room based on the categorization, and associating a timer with the categorized chat room.

2. The system of claim 1, wherein the video conferencing agent creates a user datagram protocol (UDP) server and UDP client sockets implementation for communications.

3. The system of claim 2, wherein the UDP server, acting as a receiver, listens for incoming datagrams on a specific port.

4. The system of claim 1, wherein the generated unique ID includes a user ID and a platform ID.

5. The system of claim 1, wherein the unique ID and timestamp are generated by a bot or a software program or application.

6. The system of claim 1, wherein the message includes at least a text message, an audio message, or a video message.

7. The system of claim 1, wherein chat UI includes a drop-down menu for toggling messages or responses, the drop-down menu includes a plurality of conference platforms and enabling the user to choose the conference platform of interest.

8. The system of claim 1,
wherein the chat UI is generated on each platform based on request of the user of the non-host video conference platforms and response from the host video conference platform, and
wherein the chat UI is destroyed after the live video session concludes.

9. The system of claim 1, wherein chat bot is used to create the secondary chat room using natural language processing.

10. The system of claim 1, wherein the secondary chat room is associated with a timer which is decided based on a sentiment score of the users of the chat room.

11. A method for enabling communication between host and non-host video conference platforms, the method comprises:
broadcasting a live video session embedded with a chat link to one or more non-host video conference platforms, wherein the live video session is started on the host video conference platform;
generating a unique identification (ID) for each user of the non-host video conference platforms in response to a click on the chat link and appending the generated unique ID and timestamp with each message from the user;
generating a chat user interface (UI) on each platform to display the message from the user along with the generated unique ID, wherein the chat UI incorporates a toggling function to enable the user to select a conference platform of interest; and
receiving a response on the message from a user of the host video conference platform or from a second user of the non-host video conference platform and integrating the response in the chat UI with respect to the message of the user of the non-host video conference platform.

12. The method of claim 11, the method further comprising
creating a context based secondary chat room to display message and responses of same context, and
wherein a chat room provides a dedicated space for users to view and engage in conversations related to a specific topic or context.

13. The method of claim 11, wherein a chat bot is used to create a secondary chat room using natural language processing.

14. The method of claim 11, wherein a secondary chat room is associated with a timer which is decided based on a sentiment score of the users of a chat room.

15. The method of claim 11, wherein the non-host video conference platforms are different than the host video conference platform.

16. The method of claim 11, wherein the generated unique ID includes a user ID and a platform ID.

17. The method of claim 11, further comprising:
generating and embedding the chat link with the live video session starting on the host video conference platform.

18. One or more non-transitory computer-readable storage media storing one or more computer programs including computer-executable instructions that, when executed by one or more processors of an electronic device individually or collectively, cause the electronic device to perform operations, the operations comprising:
broadcasting a live video session embedded with a chat link to one or more non-host video conference platforms, wherein the live video session is started on the host video conference platform;
generating a unique identification (ID) for each user of the non-host video conference platforms in response to a click on the chat link and appending the generated unique ID and timestamp with each message from the user;
generating a chat user interface (UI) on each platform to display the message from the user along with the generated unique ID, wherein the chat UI incorporates a toggling function to enable the user to select a conference platform of interest; and
receiving a response on the message from a user of the host video conference platform or from a second user of the non-host video conference platform and integrating the response in the chat UI with respect to the message of the user of the non-host video conference platform.

19. The one or more non-transitory computer-readable storage media of claim 18, the operations further comprising:
creating a context based secondary chat room to display message and responses of same context,
wherein the chat room provides a dedicated space for users to view and engage in conversations related to a specific topic or context.
